(19) United States
(12) Patent Application Publication
(10) Pub. No.: US 2025/0279871 A1
(43) Pub. Date: Sep. 4, 2025

(54) SIGNALING OF PATHLOSS OFFSET FOR POWER CONTROL

(71) Applicant: Samsung Electronics Co., Ltd., Suwon-si (KR)

(72) Inventors: Shiyang Leng, Little Elm, TX (US); Seungri Jin, Seoul (KR); Anil Agiwal, Allen, TX (US); Emad Farag, Flanders, NJ (US); Dalin Zhu, Allen, TX (US)

(21) Appl. No.: 19/061,824

(22) Filed: Feb. 24, 2025

Related U.S. Application Data
(60) Provisional application No. 63/559,687, filed on Feb. 29, 2024.
(60) Provisional application No. 63/567,781, filed on Mar. 20, 2024.
(60) Provisional application No. 63/670,583, filed on Jul. 12, 2024.
(60) Provisional application No. 63/699,549, filed on Sep. 26, 2024.

(51) Int. Cl. H04L 5/00; H04W 52/24

(52) U.S. Cl. CPC H04L 5/0094; H04W 52/242

(57) ABSTRACT

A user equipment (UE) receives receive a radio resource control (RRC) message that includes one or more pathloss offsets from a base station (BS). Each pathloss offset is associated with a respective one of one or more transmission configuration indicator (TCI) states. Then, the UE receives, from the BS, a medium access control (MAC) control element (CE) that includes one or more indicated values to update one or more pathloss offsets. Each indicated value is associated with a respective one of the one or more TCI states. The UE determines one or more updated pathloss offsets based on the one or more indicated values and transmits one or more uplink transmissions based on the one or more updated pathloss offsets and the associated TCI states.

### CROSS-REFERENCE TO RELATED APPLICATIONS

This application claims the benefit of priority from U.S. Provisional Application No. 63/559,687 entitled “TCI STATE ACTIVATION AND DEACTIVATION FOR MOBILITY,” filed Feb. 29, 2024; U.S. Provisional Application No. 63/567,781 entitled “SIGNALING OF PATHLOSS OFFSET FOR POWER CONTROL,” filed Mar. 20, 2024; U.S. Provisional Application No. 63/670,583 entitled “SIGNALING OF PATHLOSS OFFSET FOR POWER CONTROL,” filed Jul. 12, 2024; and U.S. Provisional Application No. 63/699,549 entitled “SIGNALING OF PATHLOSS OFFSET FOR POWER CONTROL,” filed Sep. 26, 2024, all which are incorporated herein by reference in their entirety.

### TECHNICAL FIELD

This disclosure relates generally to a wireless communication system, and more particularly to, for example, but not limited to, power control in wireless networks.

### BACKGROUND

Mobility management operations including network handovers represent a pivotal aspect of any wireless communication system. These systems include, for example, LTE and 5G New Radio (NR), and upcoming technologies currently coined “6G”. Mobility is presently controlled by the network with user equipment (UE) assistance to maintain optimal connection quality. The network may hand over the UE to a target cell with superior signal quality.

The inclusion of enhanced broadband mechanisms requiring high speeds and low latencies has necessitated more sophisticated handover mechanisms. Accordingly, conditional handovers (CHOs) and separately, layer 1/layer 2 triggered mobility (LTM) have been introduced to provide additional conditions for specific networks or slices thereof to increase handover speed. The use of these enhancements, however, introduces latencies of its own, at least because the network needs to conduct several data exchanges with the UE during the handover process. The initiation of a prospective handover triggered by the network consequently introduces latencies, signaling overhead, and interruption times of its own.

The description set forth in the background section should not be assumed to be prior art merely because it is set forth in the background section. The background section may describe aspects or embodiments of the present disclosure.

### SUMMARY

An aspect of the disclosure provides a user equipment (UE) for facilitating communication in a wireless network. The UE comprises a transceiver configured to: receive, from a base station (BS), a radio resource control (RRC) message that includes one or more pathloss offsets, each pathloss offset being associated with a respective one of one or more transmission configuration indicator (TCI) states; and receive, from the BS, a medium access control (MAC) control element (CE) that includes one or more indicated values, each indicated value being associated with a respective one of the one or more TCI states, wherein the one or more indicated values are used to update the one or more pathloss offsets. The UE comprises a processor operably coupled to the transceiver. The processor configured to determine one or more updated pathloss offsets based on the one or more indicated values. The transceiver is further configured to transmit one or more uplink transmissions, each uplink transmission being based on a respective updated pathloss offset and a corresponding TCI state.

In some embodiments, each TCI state is a joint TCI state or an uplink TCI state.

In some embodiments, each indicated value is an integer in a range from 0 to a predetermined maximum value.

In some embodiments, each updated pathloss offset is determined as (A−C)×B dB, wherein A is an indicated value associated with a TCI state, B is a predetermined step size, and C is a predetermined value.

In some embodiments, the MAC CE includes one or more TCI state identifiers, each TCI state identifier indicating a TCI state associated with an indicated value.

In some embodiments, the MAC CE includes a serving cell identifier indicating a serving cell for which the MAC CE is applied.

In some embodiments, the MAC CE includes a bandwidth part identifier indicating a bandwidth part (BWP) associated with one or more TCI states indicated by the MAC CE.

In some embodiments, the bandwidth part identifier indicates: i) a downlink BWP, wherein an associated TCI state is a joint TCI state; or ii) an uplink BWP, wherein an associated TCI state is an uplink TCI state.

An aspect of the disclosure provides a base station (BS) for facilitating communication in a wireless network. The BS comprises a transceiver configured to: transmit, to a user equipment (UE), a radio resource control (RRC) message that includes one or more pathloss offsets, each pathloss offset being associated with a respective one of one or more transmission configuration indicator (TCI) states; and transmit, to the UE, a medium access control (MAC) control element (CE) that includes one or more indicated values, each indicated value being associated with a respective one of the one or more TCI states, wherein the one or more indicated values are used to update the one or more pathloss offsets.

In some embodiments, each TCI state is a joint TCI state or an uplink TCI state.

In some embodiments, the MAC CE includes one or more TCI state identifiers, each TCI state identifier indicating a TCI state associated with an indicated value.

In some embodiments, the MAC CE includes a serving cell identifier indicating a serving cell for which the MAC CE is applied.

In some embodiments, the MAC CE includes a bandwidth part identifier indicating a bandwidth part (BWP) associated with one or more TCI states indicated by the MAC CE.

In some embodiments, the bandwidth part identifier indicates i) a downlink BWP, wherein an associated TCI state is a joint TCI state, or ii) an uplink BWP, wherein an associated TCI state is an uplink TCI state.

An aspect of the disclosure provides a method performed by a UE in a wireless network. The method comprises: receiving, from a base station (BS), a radio resource control (RRC) message that includes one or more pathloss offsets, each pathloss offset being associated with a respective one of one or more transmission configuration indicator (TCI) states; receiving, from the BS, a medium access control (MAC) control element (CE) that includes one or more indicated values, each indicated value being associated with a respective one of the one or more TCI states, wherein the one or more indicated values are used to update the one or more pathloss offsets; determining one or more updated pathloss offsets based on the one or more indicated values; and transmitting one or more uplink transmissions, each uplink transmission being based on a respective updated pathloss offset and a corresponding TCI state.

In some embodiments, each TCI state is a joint TCI state or an uplink TCI state.

In some embodiments, each indicated value is an integer in a range from 0 to a predetermined maximum value.

In some embodiments, each updated pathloss offset is determined as (A−C)×B dB, wherein A is an indicated value associated with a TCI state, B is a predetermined step size, and C is a predetermined value.

In some embodiments, the MAC CE includes one or more TCI state identifiers, each TCI state identifier indicating a TCI state associated with an indicated value.

In some embodiments, the MAC CE includes a serving cell identifier indicating a serving cell for which the MAC CE is applied.

In some embodiments, the MAC CE includes a bandwidth part identifier indicating a bandwidth part (BWP) associated with one or more TCI states indicated by the MAC CE.

In some embodiments, the bandwidth part identifier indicates i) a downlink BWP, wherein an associated TCI state is a joint TCI state, or ii) an uplink BWP, wherein an associated TCI state is an uplink TCI state.

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows an example process for pathloss offset configuration and updates in accordance with an embodiment.

FIG. 5 shows an example process for pathloss offset configuration and updates in accordance with an embodiment.

FIGS. 6 to 16 show examples of Pathloss Offset Update MAC CE format in accordance with various embodiments.

FIG. 17 shows an example process for pathloss offset configuration and updates in accordance with an embodiment.

FIGS. 18 to 19 show examples of Candidate Cell TCI States Activation/Deactivation MAC CE in accordance with an embodiment.

FIG. 20 shows an example of Candidate Cell TCI States Activation/Deactivation MAC CE in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic having dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHz, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

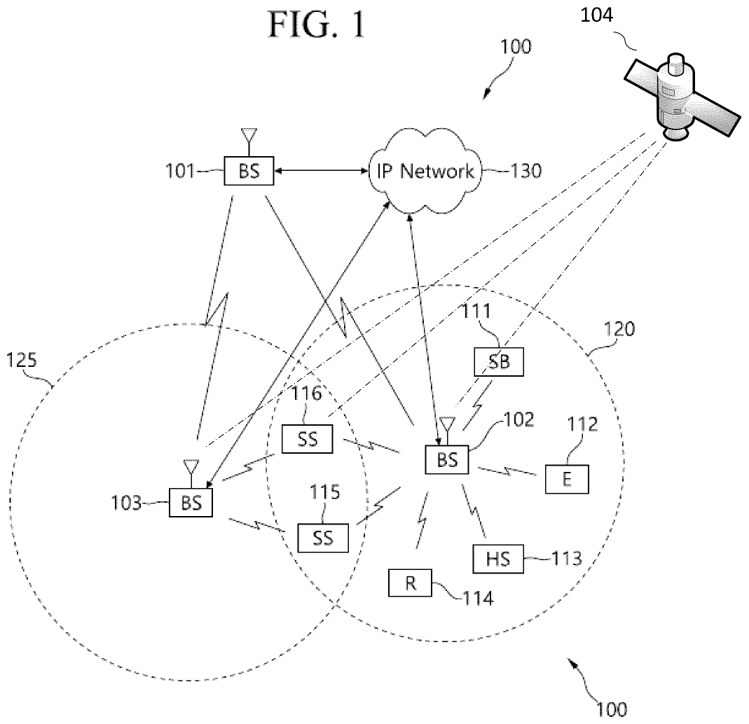

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), macro gNB, micro node, or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with BSs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or 103 can communicate directly with IP network 130 and provide UEs with direct wireless broadband access to the network 130. Further, gNB 101, 102, and/or 103 can provide access to other or additional external networks, such as external telephone networks or other types of data networks.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. The BSs 102 and 103 can also be on board the communication satellite(s) 104. One or more of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications.

As described in more detail below, one or more of the UEs 111-116 include circuitry, programing, or a combination thereof for supporting mobility in wireless networks. In certain embodiments, one or more of the BSs 101-103 include circuitry, programing, or a combination thereof to mobility in wireless networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

The controller/processor can include one or more processors or other processing devices that control the overall operation of the BS 101 (FIG. 1). For example, the controller/processor may control the reception of uplink signals and the transmission of downlink signals by the UEs, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

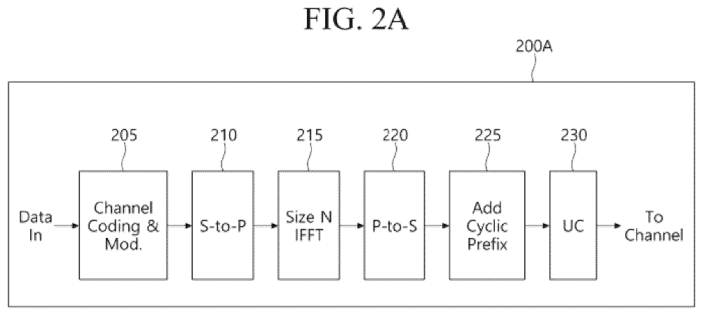

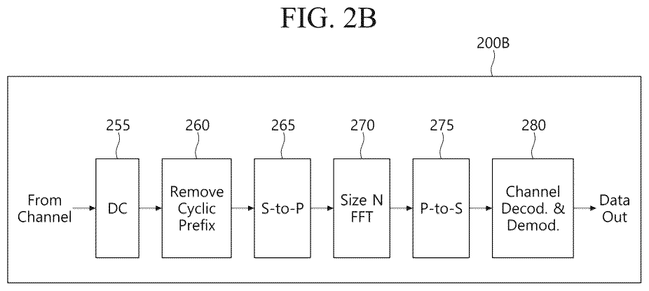

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200B may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible. In some embodiments, the transmit path 200A and the receive path 200B is configured to support mobility in wireless networks as described in various embodiments of the present disclosure.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1). The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory(ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

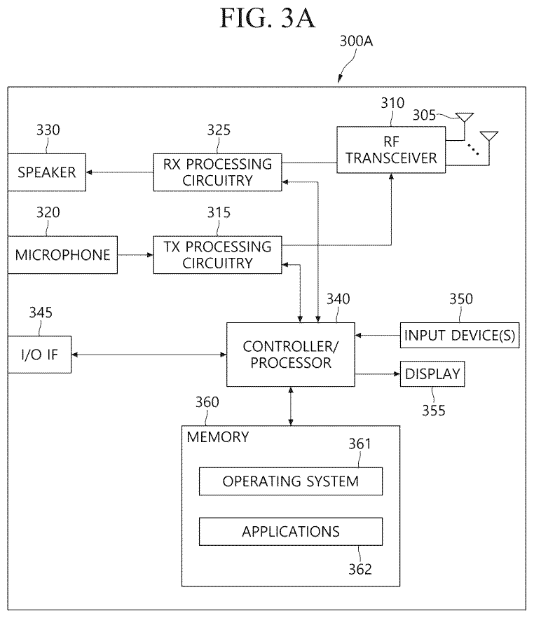

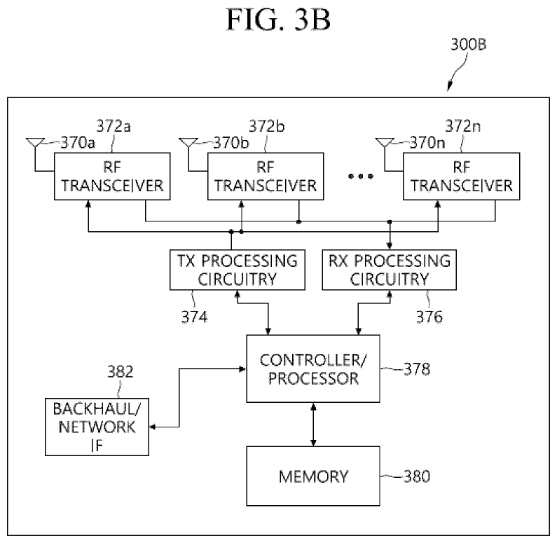

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 coupled to the processor 340, directly or through intervening elements. The main processor 340 is also capable of executing other processes and programs resident in the memory 360, such as CLTM in wireless communication systems as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. For example, the main processor 340 may execute processes to support mobility in wireless networks as described in various embodiments of the present disclosure. The main processor 340 is also coupled to the I/O interface 345, which provides the UE 300A with the ability to connect to other devices such as laptop computers and handheld computers. The I/O interface 345 is the communication path between these accessories and the main controller 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUs). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-372N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. As another example, the processor 378 could support mobility in wireless networks. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting CLTM in wireless communication systems as described in embodiments of the present disclosure. In some embodiments, the controller/processor 378 supports communications between entities, such as web RTC. The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5G, 5G-A, LTE, or LTE-A), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning an uplink of transceiver to a certain frequency and establishing the downlink using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one transmission or receive per RF transceiver).

As an example, Release13 of the LTE standard supports up to 16 CSI-RS [channel status information-reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel.14 LTE. For next generation cellular systems such as 5G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power) and reports the results to the BS.

The BS 300B of FIG. 3B may also include additional or different types of memory 380, including dynamic random-access memory (DRAM), non-volatile flash memory, static RAM (SRAM), different levels of cache memory. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms (e.g., CLTM) may be formulated by the inventors and designed to assist in providing an efficient description of the unique features within the disclosure.

The following documents are hereby incorporated by reference in their entirety into the present disclosure as if fully set forth herein: i) 3GPP TS 38.300 v18.1.0; ii) 3GPP TS 38.331 v18.1.0; iii) 3GPP TS 38.321 v18.1.0; and iv) 3GPP TS 38.213 v18.2.0.

In 5G New Radio (NR), a heterogeneous network can be deployed to enhance uplink (UL) throughput. Since a macro gNB and micro nodes differ in power rating, a UE may receive downlink (DL) transmissions from the macro gNB but transmit UL transmissions to either the macro gNB or non-co-located micro nodes in order to maximize UL throughput. As an option to further reduce energy consumption, the micro nodes can reduce or even turn off DL transmissions.

In NR Release 19, enhancements on UL power control are necessary in order to support such deployment. For instance, when pathloss reference signal (RS) is transmitted from the macro gNB while the UE transmits UL transmissions to the micro nodes, the pathloss measured from the macro gNB's pathloss RS may not be accurate. Therefore, it is necessary to configure the UE with a pathloss offset to enable a more accurate calculation of the pathloss associated with the micro nodes.

For UL transmission to micro nodes, it is necessary to specify how the pathloss information for the UL channel is signalled. More specifically, since UL RS can change dynamically, the pathloss information for UL channel also needs to be dynamically updated. Therefore, the details of dynamic pathloss updates in UL channel need to be specified.

The disclosure provides various embodiments of signalling pathloss information and dynamic updates on pathloss for UL channel via an RRC message and a medium access control (MAC) control element (CE).

In some embodiments, a UE receives an RRC message (e.g., an RRCReconfiguration message) that includes a configuration of pathloss offset per bandwidth part (BWP) per serving cell. The UE applies the received configuration for UL power control. Then, the UE receives a MAC CE that includes update information for the pathloss offset on a BWP for a serving cell and applies the received pathloss offset updates for UL power control accordingly. From network perspective, the network transmits an RRC message (e.g., an RRCReconfiguration message) that includes a configuration of pathloss offset per BWP per serving cell, and a MAC CE that includes update information for the pathloss offset on a BWP for a serving cell.

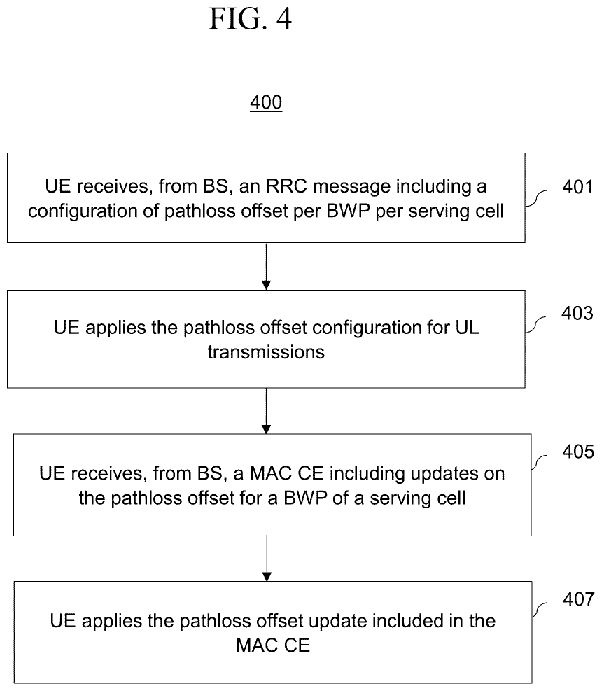

FIG. 4 shows an example process 400 for pathloss offset configuration and updates in accordance with an embodiment. For explanatory and illustration purposes, the process 400 may be performed by a UE. Although one or more operations are described or shown in a particular sequential order, in other embodiments the operations may be rearranged in a different order, which may include performance of multiple operations in at least partially overlapping time periods.

Referring to FIG. 4, the process 400 may begin in operation 401. In operation 401, a UE receives, from a BS, an RRC message that includes a configuration of pathloss offset per BWP per serving cell. In an embodiment, the RRC message is an RRCReconfiguration message, and the BS is a macro gNB. The configuration may include one or more pathloss offsets for UL channel for one or more BWPs for one or more serving cells. Then, the process 400 proceeds to operation 403.

In operation 403, the UE applies the received configuration for pathloss offset for UL transmission, including UL power control. Then, the process 400 proceeds to operation 405.

In operation 405, the UE, from the BS, a MAC CE that includes update information on the pathloss offset for a BWP of a serving cell. Detailed embodiments regarding the updated information are presented below. Then, the process 400 proceeds to operation 407.

In operation 407, the UE applies the updated pathloss offset for the BWP of the serving cell for UL transmissions. In an embodiment, the UE calculates an updated pathloss offset based on the pathloss offset received via the RRC message and the update information received via the MAC CE for UL power control. Then, the UE transmits UL transmissions based on the calculated updated pathloss offset, for example, to a micro node. In some aspects, the UL transmissions can be transmissions of uplink frame or transmissions of a UL RS (e.g., PUSCH, PUCCH, SRS, or PRACH).

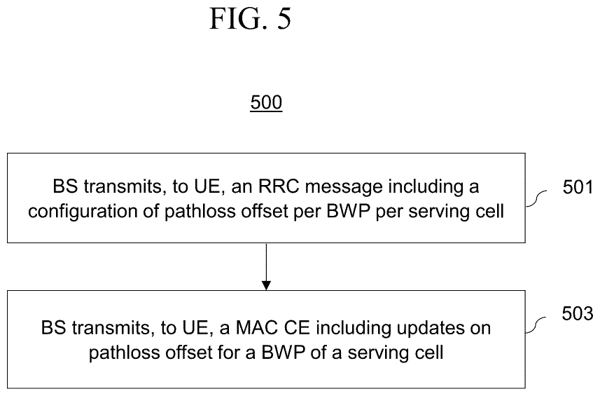

FIG. 5 shows an example process 500 for pathloss offset configuration and updates in accordance with an embodiment. For explanatory and illustration purposes, the process 500 may be performed by a BS. Although one or more operations are described or shown in a particular sequential order, in other embodiments the operations may be rearranged in a different order, which may include performance of multiple operations in at least partially overlapping time periods.

Referring to FIG. 5, the process 500 may begin in operation 501. In operation 501, a BS transmits, to a UE, an RRC message that includes a configuration of pathloss offset per BWP per serving cell. In an embodiment, the RRC message is an RRCReconfiguration message, and the BS is a macro gNB. The configuration may include one or more pathloss offsets for UL channel for one or more BWPs for one or more serving cells. Then, the process 500 proceeds to operation 503.

In operation 503, the BS transmits, to the UE, a MAC CE that includes update information on the pathloss offset for a BWP of a serving cell.

In some embodiments, for the configuration of pathloss offset per BWP per serving cell, a pathloss offset on a BWP of a serving cell may be configured per TCI state (e.g., a joint TCI state or an UL TCI state), per PUCCH (physical uplink control channel) resource ID, or per PUSCH (physical uplink shared channel) resource ID, or per SRS (Sounding Reference Signal) resource set ID, per SRS resource ID, and/or per pathloss reference signal ID for PUCCH/PUSCH/SRS. For example, a pathloss offset can be configured for each joint TCI state per BWP per serving cell or for each UL TCI state per BWP per serving cell.

In some embodiments, an RRC parameter, referred to as ‘pathlossOffset’ in this disclosure, is used to configure the pathloss offset value to calculate pathloss for UL channels or UL RS (e.g., PUSCH, PUCCH, or SRS). The UE may be configured with the RRC parameter pathlossOffset, for each joint TCI state per DL BWP per serving cell. Additionally, the UE may be configured with the RRC parameter pathlossOffset for each UL TCI state per UL BWP per serving cell.

In some embodiments, the RRC parameter pathlossOffset for a TCI state (including joint TCI state and UL TCI state) indicates the pathloss offset value to calculate the pathloss for transmissions on a UL channel or transmissions of a UL RS (e.g., PUSCH, PUCCH, or SRS) based on the TCI state. The value or indication of the parameter pathlossOffset may be signalled as a value (e.g., integer) X, from Xₘᵢₙ (e.g., 0) to Xₘₐₓ. The value of Xₘᵢₙ and Xₘₐₓ may be pre-determined values (e.g., integers). For instance, Xₘᵢₙ is −12 dB and Xₘₐₓ is 60 dB. In an implementation, an actual pathloss offset to be applied may be X dB. In another implementation, an actual pathloss offset to be applied may be determined as (X−Y) dB, where X is the parameter value and Y is a fixed value. Y may be a pre-determined value, which may be 0, a positive value (integer), or a negative value (integer). In another implementation, the actual pathloss offset to be applied may be determines as (X−Y)×A dB, where X is the parameter value, Y is a fixed value, and A is a step size. The step size can be 4 dB. Y and A may be predetermined values. Y can be 0, a positive value (integer), or a negative value (integer). For instance, X can be an integer from −3 to 15 (i.e., Xₘᵢₙ=−3, Xₘₐₓ=15), Y can be 0, and A can be 4. In this case, the actual pathloss offset set to be applied is a value among −12 dB, −8 dB, −4 dB, 0 dB, 4 dB, . . . , 60 dB. In another implementation, the actual pathloss offset to be applied may be determines as (X−Y)/B dB, where X is the parameter value, Y is a fixed value, and A is a step size. The step size can be 4 dB. Y and B are predetermined values. Y may be 0, a positive value (integer), or a negative value (integer).

In some embodiments, for the configuration of pathloss offset per BWP per serving cell, a list of pathloss offsets on a BWP of a serving cell may be configured. Each pathloss offset (e.g., RRC parameter pathlossOffest) is identified by an identifier, for example, an RRC parameter, referred to as ‘pathlossOffsetID’ in this disclosure. The pathlossOffsetID may be configured per TCI state (e.g., a joint TCI state or an UL TCI state), per PUCCH resource ID, per PUSCH resource ID, per SRS resource set ID, per SRS resource ID, and/or per pathloss reference signal ID for PUCCH/PUSCH/SRS. If the list of pathloss offset is configured on a BWP of a serving cell and the pathloss offset ID is absent for a TCI state (e.g., a joint TCI state and/or an UL TCI state), for a PUCCH resource ID, for a PUSCH resource ID, for a SRS resource set ID, for a SRS resource ID, and/or for a pathloss reference signal ID for PUCCH/PUSCH/SRS, a predetermined default pathloss offset value may be applied accordingly.

In some embodiments, the network may transmit a MAC CE to dynamically update the pathloss offset information for one or more TCI states. For convenience, the MAC CE can be referred to as ‘Pathloss Offset Update MAC CE’ in this disclosure. One or more MAC CEs may be introduced for dynamic updates on pathloss offset information. The Pathloss Offset Update MAC CE may include one or more entries (or fields) for pathloss offset information. Table 1 shows an example of eLCIDs (extended Logical Channel ID) assigned for the Pathloss Offset Update MAC CE. Table 1 shows values of one-octet eLCID for DL-SCH (downlink shared channel).

TABLE 1

| Codepoint | Index | eLCID values |
|---|---|---|
| X1 | Y1 | Pathloss Offset Update MAC CE |
| X2 | Y2 | Multi-Entry Pathloss Offset Update MAC CE |
| X3 | Y3 | Single-Entry Pathloss Offset Update MAC CE |

Referring to Table 1, various Pathloss Offset Update MAC CEs can be identified by the Codepoint and Index.

In some embodiments, the UE may receive a MAC PDU (Protocol Data Unit) from the network that includes a MAC subheader with a LCID or an eLCID value assigned for a Pathloss Offset Update MAC CE. Then, the UE may identify the Pathloss Offset Update MAC CE included in the MAC PDU based on the LCID or eLCID value. If the UE receives a Pathloss Offset Update MAC CE, the MAC entity may indicate, to a lower layer (e.g., PHY), pathloss offset information included in the MAC CE. The UE applies each pathloss offset value indicated by a pathloss offset field in the MAC CE for the associated TCI state for transmissions in a UL channel (e.g., PUCCH, PUSCH, or PRACH (physical random access channel)) or transmissions of UL RS (e.g., SRS) in the lower layer (e.g., PHY). For an UL transmission using a TCI state, the UE can use the pathloss offset value which is latest received either in the RRC message or in the MAC CE.

In some embodiments, the Pathloss Offset Update MAC CE may have a variable size or a fixed size. The Pathloss Offset Update MAC CE may include one or more serving cell IDs, one or more BWP IDs, one or more TCI state IDs, one or more joint TCI state or UL TCI state indications, one or more pathloss offsets, and/or one or more pathloss offset IDs. Each TCI state ID is mapped to a pathloss offset or a pathloss offset ID.

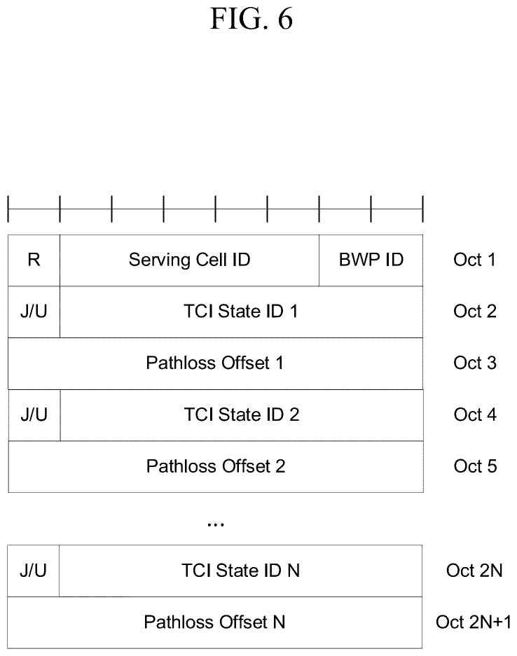

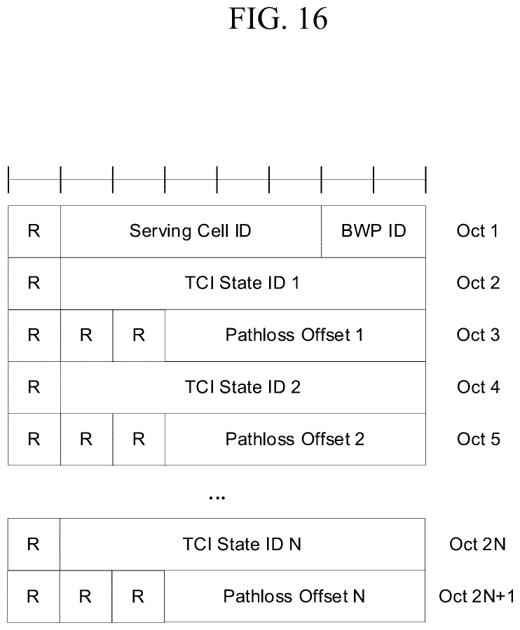

Various fields (or entries) included in the Pathloss Offset Update MAC CE are described below with reference to FIGS. 6 to 16. FIGS. 6 to 16 show examples of Pathloss Offset Update MAC CE format in accordance with various embodiments. Each Pathloss Offset Update MAC CE may include a number of octets that includes one or more fields (or entries).

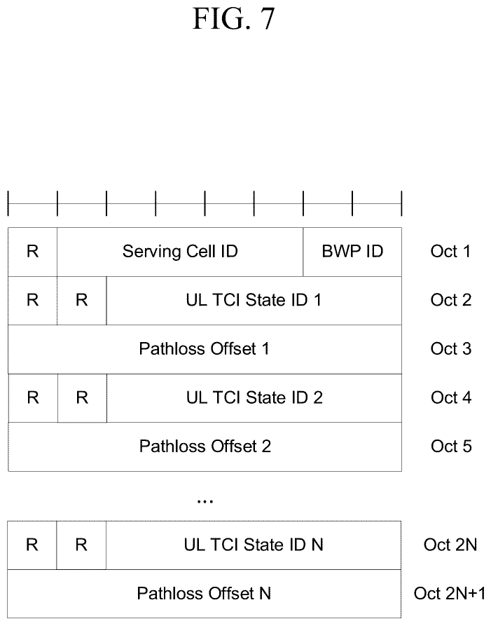

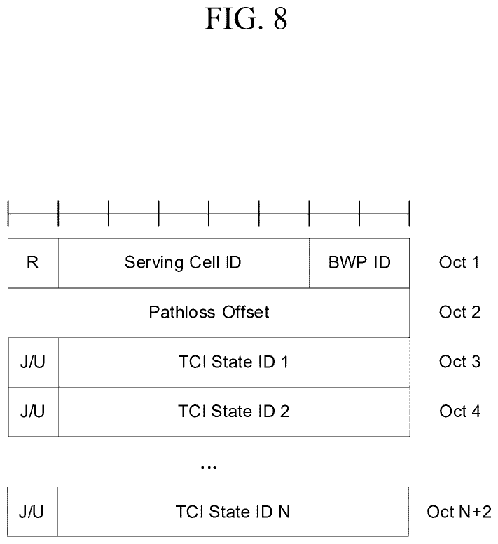

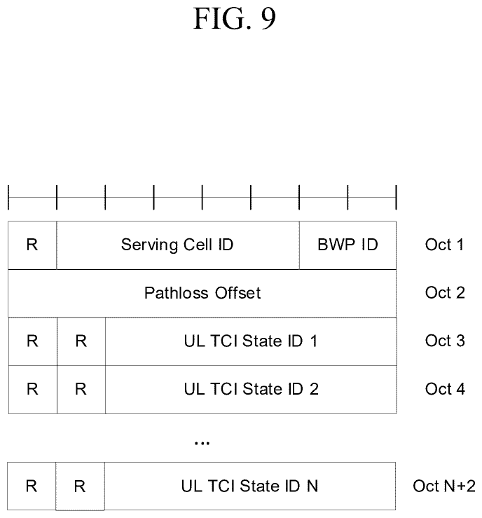

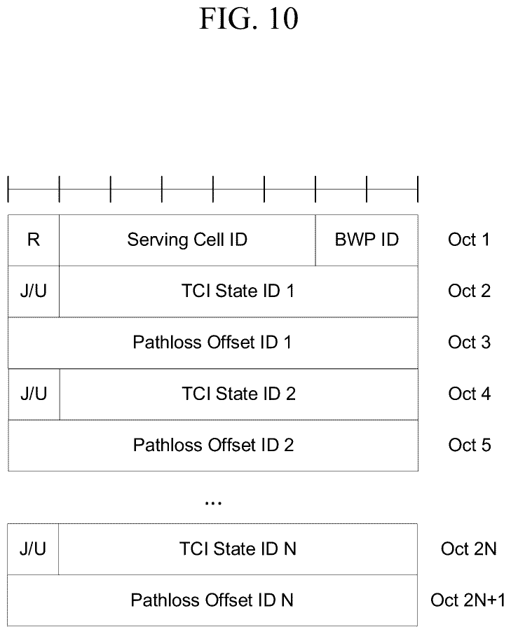

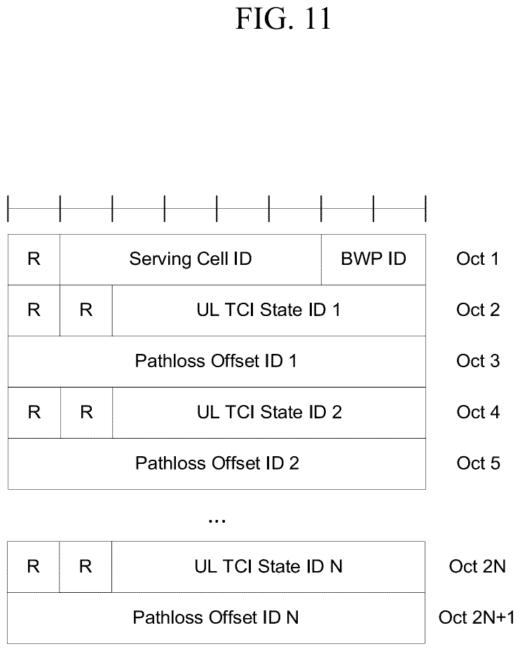

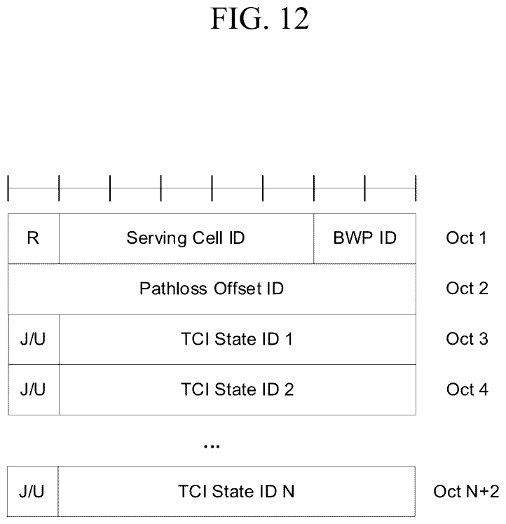

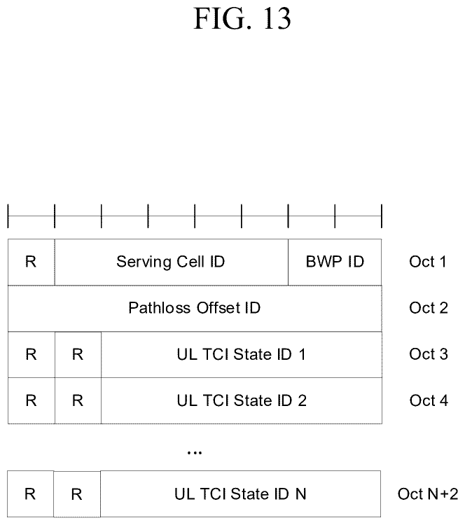

In some embodiments, a Pathloss Offset Update MAC CE may include the following fields (or entries):
Serving Cell ID field: This filed indicates the identity of serving cell to which the Pathloss Offset Update MAC CE is applied. The length of this field may be 5 bits.
BWP ID field: This field indicates a BWP as the codepoint of the DCI (Downlink Control Information) bandwidth part indicator field. The BWP can be a UL BWP. If unifiedTCI-StateType configured for the Serving Cell is joint, this field indicates a DL BWP. If unifiedTCI-State Type configured for the Serving Cell is separate, this field indicates a UL BWP. The length of the field may be 2 bits. In an embodiment, only one DL BWP ID or UL BWP ID is included in the MAC CE. In this case, all joint TCI state IDs in the MAC CE are associated with the DL BWP ID, and all UL TCI state IDs in the MAC CE are associated with the UL BWP ID. In another embodiment, multiple DL BWP IDs and/or multiple UL BWP IDs are included in the MAC CE. In this case, each indicated DL BWP ID is associated with one or more joint TCI state IDs in the MAC CE, and each indicated UL BWP ID is associated with one or more UL TCI state IDs in the MAC CE.
J/U (Joint or UL TCI state indication) field: this field indicates whether the TCI state ID in the same octet is for a joint TCI state or a UL TCI state. In an implementation, if this field is set to 1, the TCI state ID in the same octet is for a joint TCI state. Otherwise (if this field is set to 0), the TCI state ID in the same octet is for a UL TCI state. Alternatively, if this field is set to 0, the TCI state ID in the same octet is for a joint TCI state, and if this field is set to 1, the TCI state ID in the same octet is for a UL TCI state.
T/P (Indication of whether a field is for TCI state ID or pathloss offset) field: this one-bit field occupying the most significant bit of an octet indicates whether this octet is indicating a joint/UL TCI state ID or a pathloss offset. If this field is set to 0, a pathloss offset is included in this octet, which applies for all joint/UL TCI state IDs between this pathloss offset and the next pathloss offset. If this field is set to 1, a joint TCI state ID or a UL TCI state ID is included in this octet.
TCI state ID field: In an embodiment, if unifiedTCI-State Type configured for the Serving Cell is separate, this field indicates the TCI state identified by TCI-UL-State-Id as specified in TS 38.331. In another embodiment, if unifiedTCI-State Type configured for the Serving Cell is joint, this field indicates the TCI state identified by TCI-StateId or TCI-UL-State-Id as specified in TS 38.331. The length of this field may be 7 bits. If the indicated TCI state ID is for a Joint TCI state, 7-bits length TCI state ID (i.e., TCI-StateId), as specified in TS 38.331 can be used. If the indicated TCI state ID is for a UL TCI state, the most significant bit of the 7-bit TCI state ID field can be considered as the reserved bit and remainder 6 bits indicate the TCI-UL-State-Id as specified in TS 38.331. The maximum number of TCI state IDs included in the MAC CE can be 16.
Pathloss offset field: In an embodiment, the Pathloss Offset Update MAC CE includes two or more entries of pathloss offsets. In this case, this field indicates the pathloss offset for the preceding TCI state ID, as shown in FIGS. 6 and 7. In another embodiment, the Pathloss Offset Update MAC CE includes a single entry of pathloss offset. In this case, this field indicates the pathloss offset for the one or more TCI state IDs in the following octets, as shown in FIGS. 8 and 9. In an embodiment, the length of this field can be 5 bits.
Pathloss offset ID field: In an embodiment, the Pathloss Offset Update MAC CE includes two or more pathloss offset fields. In this case, this field indicates the pathloss offset for the preceding TCI state ID, as shown in FIGS. 10 and 11. In another embodiment, the Pathloss Offset Update MAC CE includes a single entry of pathloss offset. In this case, this field indicates the pathloss offset for the one or multiple TCI state IDs in the following octets, as shown in FIGS. 12 and 13. In an implementation, the pathloss offset ID may present a value among a preconfigured list of values (e.g., N values in the range [Xₘᵢₙ, Xₘₐₓ]). In an embodiment, the length of this field can be 5 bits.

In some embodiments, the pathloss offset field or the pathloss offset ID field in the Pathloss Offset Update MAC CE may indicate an integer value X, from Xₘᵢₙ (e.g., 0 or 1) to Xₘₐₓ, where Xₘₐₓ and Xₘᵢₙ is a pre-defined value (integer). For instance, Xₘᵢₙ is −12 dB and Xₘₐₓ is 60 dB. In an embodiment, the actual value applied to the pathloss offset of the associated TCI state is X dB. In another embodiment, the actual value applied to the pathloss offset may be determined as (X−Y) dB, where X is the parameter value and Y is a pre-defined value. Y can be 0, a positive value (integer), or a negative value (integer). In another embodiment, the actual value applied to the pathloss offset may be determined as (X−Y)×A dB, where X is the parameter value, and Y and A are pre-defined values. A may be a step size (e.g., 4 dB). Y can be 0, a positive value (integer), or a negative value (integer). For instance, X can be an integer from 0 to 18 (i.e., Xₘᵢₙ=0, Xₘₐₓ=18), Y can be 3, and A can be 4. In this case, the actual pathloss offset set to be applied is (X−3)×4, which results in a value among −12 dB, −8 dB, −4 dB, 0 dB, 4 dB, . . . , 60 dB. In another embodiment, the actual value applied to the pathloss offset may be determined as (X−Y)/B dB, where X is the parameter value, and Y and B are pre-defined values. B may be a step size (e.g., 4 dB). Y can be 0, a positive value (integer), or a negative value (integer). In some embodiments, the length of the pathloss offset field or the pathloss offset ID field can be 5 bits.

In some embodiments, the pathloss offset field or the pathloss offset ID field in the Pathloss Offset Update MAC CE may indicate a delta value (referred to as ‘delta pathloss offset’ in this disclosure) to be applied to the pathloss offset for the associated TCI state configured by RRC (e.g., by parameter pathlossOffset), or to be applied to the current pathloss offset value. The length of this field can be 6 bits. The most significant bit of the pathloss offset field may indicate the sign of delta pathloss offset. If the most significant bit of the pathloss offset field is set to zero (0), it indicates a positive value. Otherwise (if the most significant bit of the pathloss offset field is set to one (1)), it indicates a negative value. Alternatively, if the most significant bit of the pathloss offset field set to zero (0), it indicates a negative value, and otherwise (if it is set to one (1)), it indicates a positive value. The actual value applied to the pathloss offset for the associated TCI state may be the sum of i) the pathloss offset value indicated in the RRC (e.g., by parameter pathlossOffset) and ii) the delta pathloss offset value indicated in the pathloss field (or the pathloss offset ID field) in the MAC CE. Alternatively, the actual value applied to the pathloss offset for the associated TCI state is the sum of i) the current pathloss offset value and ii) the delta pathloss offset value indicated in the pathloss field in the MAC CE.

In some embodiments, the Pathloss Offset Update MAC CE may include a PUCCH resource ID, a PUSCH resource ID, an SRS resource set ID, an SRS resource ID, and/or a pathloss reference signal ID for PUCCH/PUSCH/SRS, which are associated with an indicated pathloss offset or an indicated pathloss offset ID.

In some embodiments, the Pathloss Offset Update MAC CE with multiple entries may have a variable size and include pathloss offset update information for multiple serving cells. For each indicated serving cell, the MAC CE may include one or more BWP IDs, one or more TCI state IDs, one or more Joint or UL TCI state indications, one or more pathloss offsets (e.g., absolute value or delta value as aforementioned), and/or one or more pathloss offset IDs. Each TCI state ID is mapped to a pathloss offset or a pathloss offset ID.

In some embodiments, a bitmap may be used to indicate the presence of the pathloss offset update information per serving cell. A single octet bitmap may be used if the highest ServCellIndex of Serving Cell is less than 8; otherwise, a four-octet bitmap may be used. If a bit with index i (denote C) in the bitmap is set to 1, it indicates the information for serving cell with ServCellIndex i is present in the MAC CE; otherwise (i.e., Cᵢ is set to 0), the information for serving Cell with servCellIndex i is absent in the MAC CE.

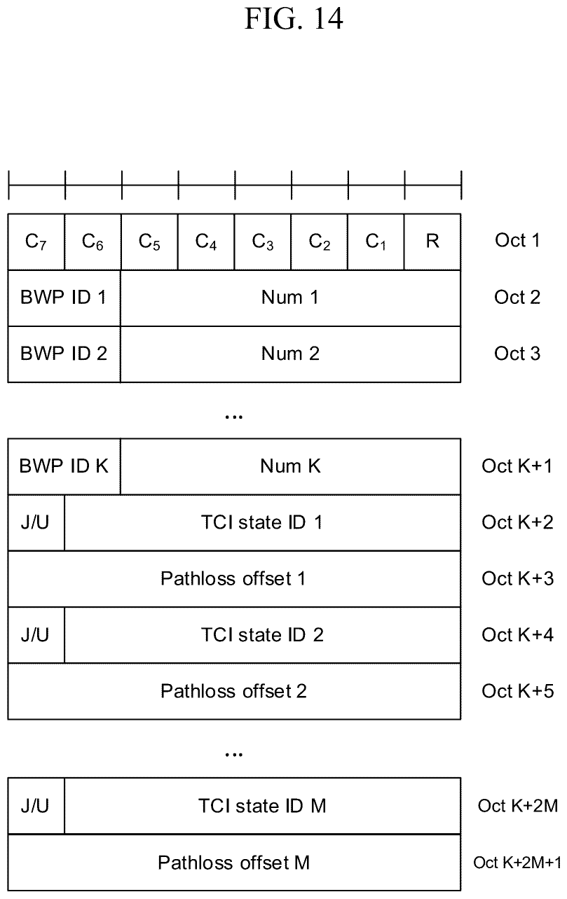

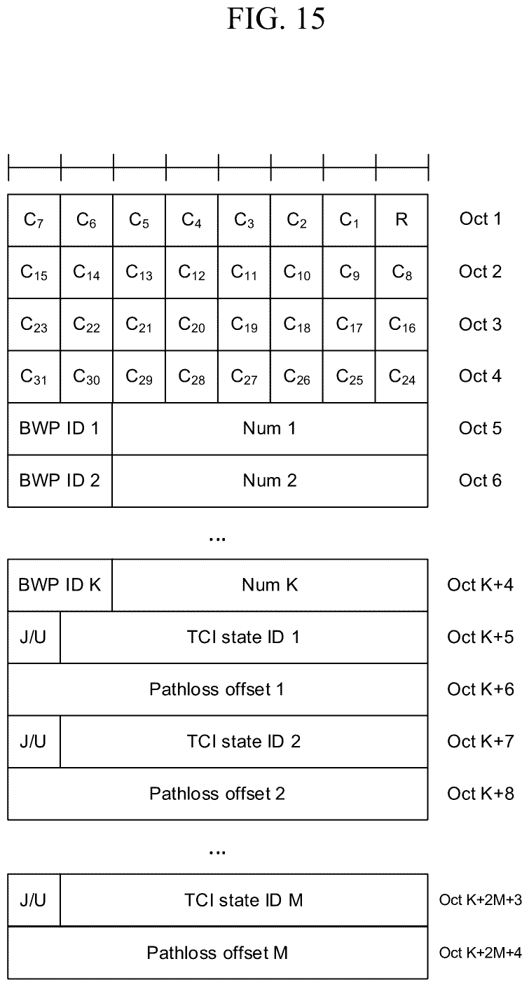

In some embodiment, the MAC CE includes a Num field indicating a number of TCI states for each serving cell. The Num field may indicate a number of octets for TCI state IDs for each serving cell. Each TCI state ID is followed by a pathloss offset field or a pathloss offset ID field. In the examples of FIGS. 14 and 15, the Num field has 6 bits for each serving cell, which may indicate values from 1 to 64. The octets for the BWP ID field and the Num field for the PCell and serving cells, for which the Cᵢ field is set to 1, are concatenated sequentially, starting with PCell and followed by other serving cells in ascending order of with ServCellIndex i.

In some embodiments, for each serving cell whose information is presented in the MAC CE, a fixed number of TCI states can be included. Each TCI state may be mapped to a pathloss offset value, where the pathloss offset value may be an absolute value or a delta value, as explained above.

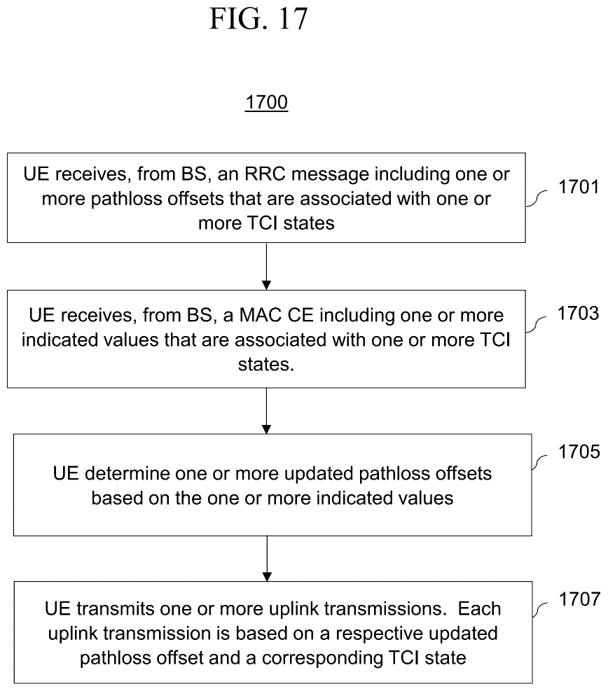

FIG. 17 shows an example process 1700 for pathloss offset configuration and updates in accordance with an embodiment. For explanatory and illustration purposes, the process 1700 may be performed by a UE. Although one or more operations are described or shown in a particular sequential order, in other embodiments the operations may be rearranged in a different order, which may include performance of multiple operations in at least partially overlapping time periods.

Referring to FIG. 17, the process 1700 may begin in operation 1701. In operation 1701, a UE receives, from a BS, an RRC message that includes a configuration of one or more pathloss offsets. Each pathloss offset is associated with a respective one of one or more TCI states. Then, the process 1700 proceeds to operation 1703.

In operation 1703, the UE receives, from the BS, a MAC CE that includes a configuration of one or more indicated values. Each indicated value is associated with a respective one of the one or more TCI states. The one or more indicated values are used to update the one or more pathloss offsets. In some aspects, each indicated value is an integer in a range from 0 to a predetermined maximum value. Then, the process 1700 proceeds to operation 1705.

In operation 1705, the UE determines one or more updated pathloss offsets based on the one or more indicated values. In some aspects, each updated pathloss offset is determined as (A−C)×B dB, wherein A is an indicated value associated with a TCI state, B is a predetermined step size, and C is a predetermined value. Then, the process 1700 proceeds to operation 1707.

In operation 1707, the UE transmits one or more uplink transmissions. Each uplink transmission is transmitted based on a respective updated pathloss offset and a corresponding TCI state.

In some embodiments, each TCI state is a joint TCI state or an uplink TCI state.

In some embodiments, the MAC CE includes one or more TCI state identifiers. Each TCI state identifier indicates a TCI state associated with an indicated value. The MAC CE includes a serving cell identifier that indicates a serving cell for which the MAC CE is applied. The MAC CE includes a bandwidth part identifier that indicates a BWP associated with one or more TCI states indicated by the MAC CE. The bandwidth part identifier indicates i) a downlink BWP, in which an associated TCI state is a joint TCI state, or ii) an uplink BWP, in which an associated TCI state is an uplink TCI state.

For mobility in connected mode, a handover is initiated by the network via higher layer signalling (e.g., RRC message) based on Layer 3 (L3) measurements. However, this procedure involves more latency, signalling overhead, and interruption time that may become the key issue in some scenarios with frequent handover, such as, UEs in high-speed vehicular environments and in FR (frequency range) 2 deployments. It is required to reduce the signalling overhead, additional latency, and interruption time in handover procedure. This brings the need of Layer 1(L1)/Layer 2(L2) Triggered Mobility (LTM), by which the handover is triggered by L1/L2 signalling based on L1 measurement. More specifically, the LTM refers to a mobility mechanism that UE switches from the source cell to a target cell with beam switching triggered by L1/L2 signalling. The beam switching is determined based on L1 measurement on beams among neighbouring cells.

For LTM, the UE performs L1 measurement and reports CSI measurement result to the network. The network determines a target cell for cell switch based on the reported result. The network activates or deactivates a list of TCI states before cell switch and indicates an activated TCI state in an LTM cell switch MAC CE. A MAC layer signalling is required to activate and/or deactivate TCI states associated with a subset of codepoints in the DCI.

The disclosure also presents various embodiments of MAC CE signalling to activate and/or deactivate TC states associated with a subset of codepoints in DCI for LTM.

In some embodiments, a MAC CE, referred to ‘Candidate Cell TCI States Activation/Deactivation MAC CE’ in this disclosure, may be used to activate and deactivate TCI states associated to a subset of codepoints in DCI for LTM.

The network may activate and deactivate the TCI states of LTM candidate cell(s) configured in Candidate TCI-State and CandidateTCI-UL-State by sending the Candidate Cell TCI States Activation/Deactivation MAC CE.

A MAC entity at a UE may perform the following operations:
1> if the MAC entity receives a Candidate Cell TCI States Activation/Deactivation MAC CE on a Serving Cell; and
   2> indicate to lower layers the information regarding the Candidate Cell TCI States Activation/Deactivation MAC CE.

The Candidate Cell TCI States Activation/Deactivation MAC CE may be identified by a MAC subheader with eLCID as specified in Table 2 that shows example values of one-octet eLCID for DL-SCH.

TABLE 2

| Codepoint | Index | LCID values |
|---|---|---|
| 0 to 216 | 64 to 280 | Reserved |
| 217 | 281 | Enhanced SP CSI reporting on PUCCH |
| | | Activation/Deactivation MAC CE |
| 218 | 282 | Cross-RRH TCI State Indication for UE- |
| | | specific PDCCH MAC CE |
| 219 | 283 | LTM Cell Switch Command |
| 220 | 284 | Candidate Cell TCI States |
| | | Activation/Deactivation |
| 221 | 285 | PSI-Based SDU Discard |
| | | Activation/Deactivation MAC CE |
| 222 | 286 | Enhanced Unified TCI state |
| | | Activation/Deactivation MAC CE for Joint TCI |
| | | States |
| 223 | 287 | Enhanced Unified TCI state |
| | | Activation/Deactivation MAC CE for Separate |
| | | TCI States |
| 224 | 288 | NCR Access Link Beam Indication MAC CE |
| 225 | 289 | NCR Downlink Backhaul Link Beam Indication |
| | | MAC CE |
| 226 | 290 | NCR Uplink Backhaul Link Beam Indication |
| | | MAC CE |
| 227 | 291 | Serving Cell Set based SRS TCI State |
| | | Indication MAC CE |
| 228 | 292 | SP/AP SRS TCI State Indication MAC CE |
| 229 | 293 | BFD-RS Indication MAC CE |
| 230 | 294 | Differential Koffset |
| 231 | 295 | Enhanced SCell Activation/Deactivation MAC |
| | | CE with one octet Cᵢ field |
| 232 | 296 | Enhanced SCell Activation/Deactivation MAC |
| | | CE with four octet Cᵢ field |
| 233 | 297 | Unified TCI States Activation/Deactivation |
| | | MAC CE |
| 234 | 298 | PUCCH Power Control Set Update for multiple |
| | | TRP PUCCH repetition MAC CE |
| 235 | 299 | PUCCH spatial relation Activation/Deactivation |
| | | for multiple TRP PUCCH repetition MAC CE |
| 236 | 300 | Enhanced TCI States Indication for UE-specific |
| | | PDCCH |
| 237 | 301 | Positioning Measurement Gap |
| | | Activation/Deactivation Command |
| 238 | 302 | PPW Activation/Deactivation Command |
| 239 | 303 | DL Tx Power Adjustment |
| 240 | 304 | Timing Case Indication |
| 241 | 305 | Child IAB-DU Restricted Beam Indication |
| 242 | 306 | Case-7 Timing advance offset |
| 243 | 307 | Provided Guard Symbols for Case-6 timing |
| 244 | 308 | Provided Guard Symbols for Case-7 timing |
| 245 | 309 | Serving Cell Set based SRS Spatial Relation |
| | | Indication |
| 246 | 310 | PUSCH Pathloss Reference RS Update |
| 247 | 311 | SRS Pathloss Reference RS Update |
| 248 | 312 | Enhanced SP/AP SRS Spatial Relation |
| | | Indication |
| 249 | 313 | Enhanced PUCCH Spatial Relation |
| | | Activation/Deactivation |
| 250 | 314 | Enhanced TCI States Activation/Deactivation |
| | | for UE-specific PDSCH |
| 251 | 315 | Duplication RLC Activation/Deactivation |
| 252 | 316 | Absolute Timing Advance Command |
| 253 | 317 | SP Positioning SRS Activation/Deactivation |
| 254 | 318 | Provided Guard Symbols |
| 255 | 319 | Timing Delta |

Referring to Table 2, the Candidate Cell TCI States Activation/Deactivation MAC CE is identified by Codepoint 220 and Index 284.

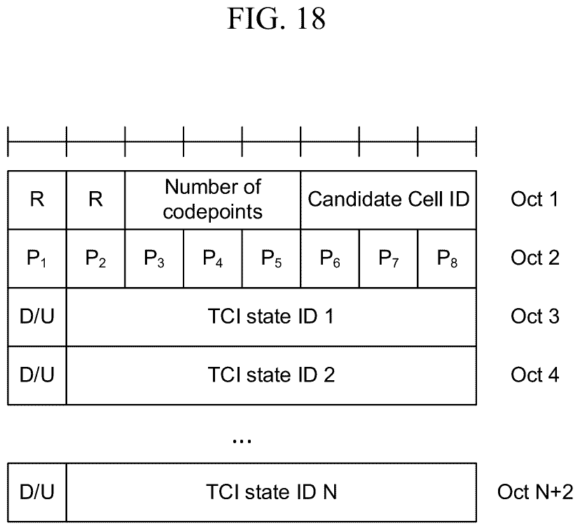

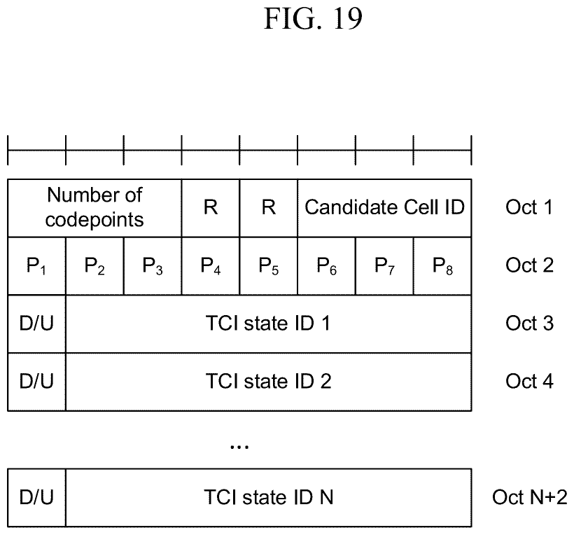

FIGS. 18 to 19 show examples of Candidate Cell TCI States Activation/Deactivation MAC CE in accordance with an embodiment. The Candidate Cell TCI States Activation/Deactivation MAC CE may have a variable size including the following fields:
Candidate Cell ID field: This field indicates the identity of an LTM candidate cell for which the MAC CE applies. It may correspond to the ltm-CandidateId minus 1 as specified in TS 38.331. The length of the field may be 3 bits;
Number of codepoints field: This field indicates the number of codepoints of the DCI Transmission Configuration Indication field to which TCI states presented or activated in this MAC CE are associated. The length of the field may be 3 bits. The value of this field may be from 1 to 8. When this field is set to value i (i=1, 2, . . . , 8), it indicates that the TCI states presented or activated in the MAC CE are associated with first i codepoints (i.e., codepoints with value 1 to i). Accordingly, the first Pᵢ fields (i.e., P₁, P₂, . . . , Pᵢ) are present, while R bits are present instead of Pᵢ₊₁, . . . , P₈.
Pᵢ field: This field indicates whether each TCI codepoint has multiple TCI states or a single TCI state. If the Pᵢ field is set to 1, the i^{th} TCI codepoint includes the DL TCI state or the UL TCI state. If the P₁ field is set to 0, the i^{th} TCI codepoint includes only the DL/joint TCI state or the UL TCI state. The codepoint to which a TCI state is mapped is determined by its ordinal position among all the TCI state ID fields;
D/U field: This field indicates whether the TCI state ID in the same octet is for a joint/downlink or an uplink TCI state. If this field is set to 1, the TCI state ID in the same octet is for joint/downlink TCI state. If this field is set to 0, the TCI state ID in the same octet is for uplink TCI state;
TCI state ID: This field indicates the TCI state identified by TCI-StateId in ltm-DL-OrJointTCI-StateToAddModList or TCI-UL-StateId in ltm-UL-TCI-StatesToAddModList as specified in TS 38.331. If D/U is set to 1, 7-bits length TCI state ID (i.e., TCI-StateId as specified in TS 38.33)1 is used. If D/U is set to 0, the most significant bit of TCI state ID is considered as the reserved bit and remaining 6 bits indicate the TCI-UL-StateId as specified in TS 38.331. The maximum number of activated TCI states may be 16, A TCI state is activated if its TCI state ID is present. Otherwise, it is deactivated.
R: Reserved bit, set to 0.

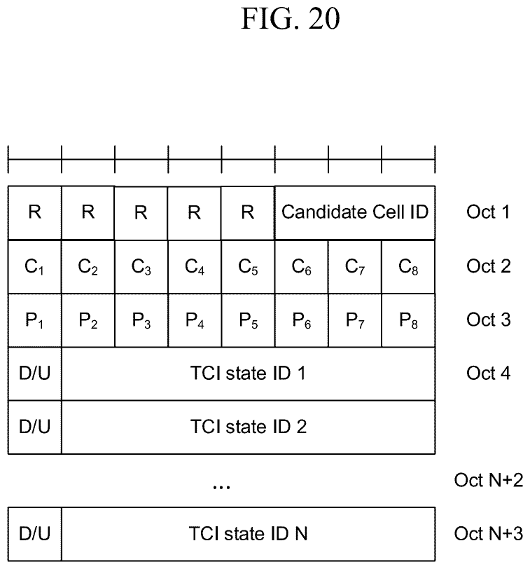

FIG. 20 shows an example of Candidate Cell TCI States Activation/Deactivation MAC CE in accordance with an embodiment. The Candidate Cell TCI States Activation/Deactivation MAC CE may have a variable size including the following fields:
Candidate Cell ID field: This field indicates the identity of an LTM candidate cell for which the MAC CE applies. It may correspond to the ltm-CandidateId minus 1 as specified in TS 38.331. The length of the field is 3 bits;
Cᵢ field: This field indicates whether TCI state(s) associated to the i-th codepoint of the DCI Transmission Configuration Indication field are presented/activated in this MAC CE. This field set to value 1 indicates Pᵢ field is present and the TCI state(s) associated to the i-th codepoint are present/activated. This field set to 0 indicates R bit is present instead of Pᵢ and the TCI state(s) associated to the i-th codepoint are absent.
Pᵢ field: This field indicates whether each TCI codepoint has multiple TCI states or a single TCI state. If the Pᵢ field is set to 1, the i^{th} TCI codepoint includes the DL TCI state and the UL TCI state. If the Pᵢ field is set to 0, the i^{th} TCI codepoint includes only the DL/joint TCI state or the UL TCI state. The codepoint to which a TCI state is mapped is determined by its ordinal position among all the TCI state ID fields;
D/U field: This field indicates whether the TCI state ID in the same octet is for a joint/downlink or an uplink TCI state. If this field is set to 1, the TCI state ID in the same octet is for joint/downlink TCI state. If this field is set to 0, the TCI state ID in the same octet is for uplink TCI state;
TCI state ID field: This field indicates the TCI state identified by TCI-StateId in ltm-DL-OrJointTCI-StateToAddModList or TCI-UL-StateId in ltm-UL-TCI-StatesToAddModList as specified in TS 38.331. If D/U is set to 1, 7-bits length TCI state ID i.e. TCI-StateId as specified in TS 38.331 is used. If D/U is set to 0, the most significant bit of TCI state ID is considered as the reserved bit and remaining 6 bits indicate the TCI-UL-StateId as specified in TS 38.331. The maximum number of activated TCI states is 16; A TCI state is activated if its TCI state ID is present. Otherwise, it is deactivated.
R: Reserved bit, set to 0.

According to various embodiments in the disclosure, a pathloss information and dynamic updates on pathloss for UL channel via an RRC message and a MAC, enabling dynamically updating the pathloss information. As a result, the UE can perform more accurate power control for UL transmission. Additionally, with precise and timely pathloss updates, UL transmissions can be better optimized, reducing transmission errors and improving overall network performance, especially in dense deployments.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE) for facilitating communication in a wireless network, the UE comprising:
a transceiver configured to:
receive, from a base station (BS), a radio resource control (RRC) message that includes one or more pathloss offsets, each pathloss offset being associated with a respective one of one or more transmission configuration indicator (TCI) states; and
receive, from the BS, a medium access control (MAC) control element (CE) that includes one or more indicated values, each indicated value being associated with a respective one of the one or more TCI states, wherein the one or more indicated values are used to update the one or more pathloss offsets; and
a processor operably coupled to the transceiver, the processor configured to:
determine one or more updated pathloss offsets based on the one or more indicated values,
wherein the transceiver is further configured to transmit one or more uplink transmissions, each uplink transmission being based on a respective updated pathloss offset and a corresponding TCI state.

2. The UE of claim 1, wherein each TCI state is a joint TCI state or an uplink TCI state.

3. The UE of claim 1, wherein each indicated value is an integer in a range from 0 to a predetermined maximum value.

4. The UE of claim 1, wherein each updated pathloss offset is determined as (A−C)×B dB, wherein A is an indicated value associated with a TCI state, B is a predetermined step size, and C is a predetermined value.

5. The UE of claim 1, wherein the MAC CE includes one or more TCI state identifiers, each TCI state identifier indicating a TCI state associated with an indicated value.

6. The UE of claim 1, wherein the MAC CE includes a serving cell identifier indicating a serving cell for which the MAC CE is applied.

7. The UE of claim 1, wherein the MAC CE includes a bandwidth part identifier indicating a bandwidth part (BWP) associated with one or more TCI states indicated by the MAC CE.

8. The UE of claim 7, wherein the bandwidth part identifier indicates:
a downlink BWP, wherein an associated TCI state is a joint TCI state; or
an uplink BWP, wherein an associated TCI state is an uplink TCI state.

9. A base station (BS) for facilitating communication in a wireless network, the BS comprising:
a transceiver configured to:
transmit, to a user equipment (UE), a radio resource control (RRC) message that includes one or more pathloss offsets, each pathloss offset being associated with a respective one of one or more transmission configuration indicator (TCI) states; and
transmit, to the UE, a medium access control (MAC) control element (CE) that includes one or more indicated values, each indicated value being associated with a respective one of the one or more TCI states, wherein the one or more indicated values are used to update the one or more pathloss offsets.

10. The BS of claim 9, wherein each TCI state is a joint TCI state or an uplink TCI state.

11. The BS of claim 9, wherein the MAC CE includes one or more TCI state identifiers, each TCI state identifier indicating a TCI state associated with an indicated value.

12. The BS of claim 9, wherein the MAC CE includes a serving cell identifier indicating a serving cell for which the MAC CE is applied.

13. The BS of claim 9, wherein:
the MAC CE includes a bandwidth part identifier indicating a bandwidth part (BWP) associated with one or more TCI states indicated by the MAC CE; and
the bandwidth part identifier indicates:
a downlink BWP, wherein an associated TCI state is a joint TCI state; or
an uplink BWP, wherein an associated TCI state is an uplink TCI state.

14. A method performed by a user equipment (UE) in a wireless network, comprising:
receiving, from a base station (BS), a radio resource control (RRC) message that includes one or more pathloss offsets, each pathloss offset being associated with a respective one of one or more transmission configuration indicator (TCI) states;
receiving, from the BS, a medium access control (MAC) control element (CE) that includes one or more indicated values, each indicated value being associated with a respective one of the one or more TCI states, wherein the one or more indicated values are used to update the one or more pathloss offsets;
determining one or more updated pathloss offsets based on the one or more indicated values; and
transmitting one or more uplink transmissions, each uplink transmission being based on a respective updated pathloss offset and a corresponding TCI state.

15. The method of claim 14, wherein each TCI state is a joint TCI state or an uplink TCI state.

16. The method of claim 14, wherein each indicated value is an integer in a range from 0 to a predetermined maximum value.

17. The method of claim 14, wherein each updated pathloss offset is determined as (A−C)×B dB, wherein A is an indicated value associated with a TCI state, B is a predetermined step size, and C is a predetermined value.

18. The method of claim 14, wherein the MAC CE includes one or more TCI state identifiers, each TCI state identifier indicating a TCI state associated with an indicated value.

19. The method of claim 14, wherein the MAC CE includes a serving cell identifier indicating a serving cell for which the MAC CE is applied.

20. The method of claim 14, wherein:
the MAC CE includes a bandwidth part identifier indicating a bandwidth part (BWP) associated with one or more TCI states indicated by the MAC CE; and
the bandwidth part identifier indicates:
a downlink BWP, wherein an associated TCI state is a joint TCI state; or
an uplink BWP, wherein an associated TCI state is an uplink TCI state.
